(19) United States
(12) Patent Application Publication
(10) Pub. No.: US 2003/0202199 A1
(43) Pub. Date: Oct. 30, 2003

(54) Black-and-white lock mode for printer

(76) Inventors: Barbara Burklin Carter, Lexington, KY (US); David William Murphy, Lexington, KY (US); Peter Eric Wallin, Lexington, KY (US); Timothy Gerard Yorkey, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/132,765

(22) Filed: Apr. 25, 2002

(51) Int. Cl. G06F 15/00; G06F 13/00; G06F 3/12; G06F 11/30; H04L 9/32

(52) U.S. Cl. 358/1.13; 358/1.14; 713/200

(57) ABSTRACT

A color printer having a black-and-white lock mode is provided by the present application. The color printer has firmware programming that is accessed through an operator panel menu that allows selected personnel to place the printer in a lock mode such that the printer will only print in black-and-white. An access code is utilized to access the lock mode such that only individuals that are provided the access code can lock and unlock the color printing function of the printer. Once the printer is in lock mode, the printer will only print in black-and-white no matter what the user's intent or the print job's source. The invention is equally applicable to all types of printers and copiers including ink jet and laser type devices.

### FIELD OF THE INVENTION

The present invention is generally directed toward printers. More particularly, the invention is directed toward a color printer that can be locked into a black-and-white only printing mode.

### BACKGROUND OF THE INVENTION

Modem businesses use large numbers of printers for a wide variety of tasks. Some of the tasks for which these printers are used require a color printout while black-and-white printouts are acceptable for others. Fortunately, many modem printers are capable of producing both color and black-and-white printouts. However, the cost of producing a color printout is substantially higher than the cost of producing a black-and-white printout. Thus, in the interest of saving money, many businesses maintain separate printers for producing color and black-and-white only printouts to attempt to limit the printing of color printouts to those cases were its is absolutely necessary. These separate printers frequently require different supply items, maintenance and user interfaces and require twice as many resources and overhead to operate. Therefore, what is needed is an improved method and apparatus for controlling a color printer's ability to print color printouts.

### SUMMARY OF THE INVENTION

The foregoing and other needs are met by a printer that is capable of producing both color and black-and-white prints. The printer includes a print mode selection mechanism for selecting between at least two printing modes such that when the printer is placed in a first printing mode the printer can produce either black-and-white or color prints and when the printer is placed in a second printing mode the printer can produce only black-and-white prints. A lock mechanism is included such that when the lock mechanism is engaged the printing mode of the printer can not be changed between the first printing mode and the second printing mode and when the lock mechanism is disengaged the printing mode of the printer can be changed between the first printing mode and the second printing mode. A mechanical key is used to engage and disengage the lock mechanism. Alternatively, the printer may be provided with a key pad that allows an operator of the printer to enter an access code through the key pad that is verified by a processor in the printer to engage or disengage the lock mechanism of the printer.

A printer constructed in accordance with the above discussed embodiment provides a number of advantages over prior art devices for producing color and black-and-white only printouts. For example, the embodiment enables restricted access to the ability to print relatively expensive color printouts. In addition, the above discussed embodiment achieves this beneficial result without requiring separate color and black-and-white printers. Furthermore, the use of access codes and mechanical keys to restrict access to the color printing function of the printer allows the number and identity of individuals that are authorized to change the printing mode of the printer to be easily controlled and managed. Therefore, the above discussed embodiment of the present invention is a substantial improvement upon the prior art.

In another embodiment, the present invention is directed toward a method of controlling a printer that is designed to produce both color and black-and-white printouts. The method includes limiting the printer to only producing black-and-white printouts when the printer is placed in a black-and-white printing mode and enabling the printer to produce color printouts when the printer is placed in a color printing mode. The ability to place the printer in the color mode is limited by requiring a user desiring to place the printer in the color printing mode to enter a digital access code. The digital access code is verified against a list of digital access codes that correspond to authorized users to determine whether or not the user is authorized to place the printer in the color printing mode. The printer is placed in the color printing mode if the digital access code corresponds to a user authorized to place the printer in the color printing mode.

In yet another embodiment of the present invention, a method of controlling a printer wherein the printer is capable of producing both color and black-and-white prints is provided. In accordance with the method, a set of printing instructions is examined to determine if the instructions request the printing of a color print or a black-and-white print. A black-and-white print is produced if the printing instructions indicate that a black-and-white print has been requested. However, a color print is only produced if the printing instructions indicate that a color print has been requested and a color printing mode is enabled. An error message is produced if the printing instructions indicate that a color print has been requested and the color printing mode is not enabled and the user is prompted to enter an access code. The color printing mode is enabled if the entered access code corresponds to an authorized access code. The access code allows the number of users that can alter the printing mode of the printer to be limited to a selected subset of users.

As discussed above, the ability to limit a color printer to producing only relatively inexpensive black-and white printouts saves money by limiting the number of relatively expensive color printouts. Furthermore, the use of access and identification codes allows color printouts to be produced by authorized individuals when necessary without requiring separate printers or actual physical monitoring of the printer by personnel. Therefore, the above discussed embodiments of the present invention offer a number of advantages over the prior art.

### BRIEF DESCRIPTION OF THE DRAWINGS

Further advantages of the invention will become apparent by reference to the detailed description of preferred embodiments when considered in conjunction with the drawings, which are not to scale, wherein like reference characters designate like or similar elements throughout the several drawings as follows:

FIG. 1 is a block diagram of an apparatus constructed in accordance with an embodiment of the present invention;

FIG. 2 is a block diagram of another apparatus constructed in accordance with an embodiment of the present invention;

FIG. 3 is a flow chart of a method of limiting access to the ability to produce color printouts in accordance with an embodiment of the present invention; and

FIG. 4 is a flow chart of a method of operating a color printer in accordance with an embodiment of the present invention.

### DETAILED DESCRIPTION OF THE INVENTION

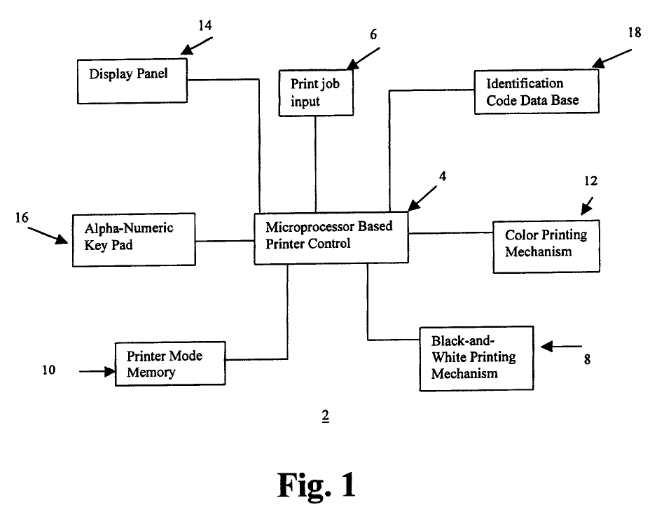

Referring now to FIG. 1, a block diagram of a printing apparatus 2 constructed in accordance with an embodiment of the present invention is shown. The printing apparatus 2 is controlled by a microprocessor based printer control 4. The microprocessor based printer control 4 receives a print request from a print job input 6. The print request received from the print job input 6 contains printing instructions that detail how the printing should be carried out. In particular, the print request will indicate whether a black-and-white or color printout has been requested. If a black-and-white printout is requested the microprocessor based printer control 4 will instruct the black-and-white printing mechanism 8 to produce the desired black-and-white printout. However, if the print request indicates that a color printout is desired, the microprocessor based printer control 4 will check a printer operating mode value stored in the printer mode memory 10 to determine whether or not the printing apparatus 2 is currently in a color printing mode or a black-and-white only printing mode. If the printing apparatus 2 is in the coloring printing mode, the microprocessor based printer control 4 will instruct the color printing mechanism 12 to produce the requested color printout.

If the microprocessor based printer control determines the print request is for a color printout and the printer mode memory 10 indicates that the printer is in black-and-white only print mode, the microprocessor based printer control 4 will control the display panel 14 to display a message that requests the user of the printer to enter an identification code if the user wants to produce a color printout. The user enters the identification code through an alpha-numeric key pad 16. The microprocessor based printer control 4 then compares the entered identification code with a list of identification codes contained in an identification code database 18. The identification codes stored in the identification code database 18 correspond to identification codes given to individuals that are authorized to change the printing mode of the printing apparatus 2. If the identification code entered by the user of the printing apparatus corresponds to an authorized code contained in the identification code database 18, the microprocessor based printer control 4 will change the operating mode of the printer stored in the printer mode memory 10 to a color printout mode and instruct the color printing mechanism 12 to print the desired color printout. Once the color printout has been produced, the user may then place the printing apparatus 2 back into the black-and-white only operating mode by entering an authorized identification code number and instructing the microprocessor based printer control accordingly. In an alternative embodiment, the identification code and verifying database may be replaced with a mechanical system such as a key lock. In such a system, turning the key would shift the mode of the printer between a black-and-white only mode and a full color mode.

The embodiment of the present invention shown in FIG. 1 offers a number of benefits over a standard printer. For example, the ability to restrict the printing of color printouts to authorized users allows an employer to reduce the increased costs incurred in unnecessarily producing color printouts. In addition, the embodiment enables the employer to realize this benefit without incurring the added costs associated with providing separate color and black-and-white printers with restricted access. Thus, the embodiment of FIG. 1 substantially improves the efficiency of a business that requires occasional printing of color printouts.

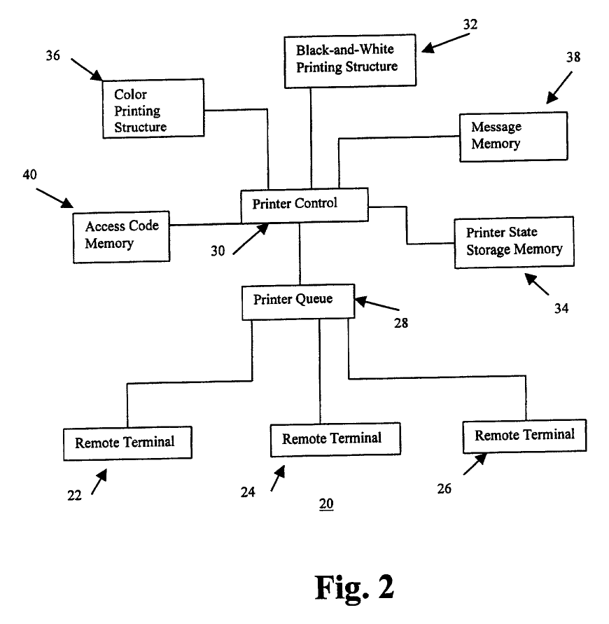

Another preferred embodiment of the present invention is depicted in FIG. 2. More particularly, FIG. 2 depicts a block diagram of an embodiment of the present invention designed for use with multiple remote terminals 22, 24 and 26. The printing system of FIG. 2 consists of multiple remote terminals 22, 24 and 26 connected to a printer queue 28. The printer queue receives and stores print requests received from the multiple remote terminals 22, 24 and 26. A printer control 30 examines the print requests stored in the printer queue 28. If the printer control determines that a print request is directed toward a black-and-white printout, the printer control 30 instructs a black-and-white printing structure 32 to prepare the requested black-and-white printout. Conversely, if the printer control 30 examines the print request stored in the printer queue 28 and determines that the request is directed toward a color printout, the printer control 30 will access the printer state storage memory 34 to determine the operating mode of the printing system 20. If the examination of the printer state storage memory 34 indicates that the printing system 20 is operating in a mode that allows the printing of color printouts, the printer control 30 will instruct the color printing structure 36 to produce the requested color printout. However, if a color printout has been requested and the examination of the printer state storage memory 34 indicates that the printing system 20 is in a black-and white printout only operating mode, the printing system will enter into a verification routine as described in more detail below.

The verification routine performed by the printing system 20 enables the system to determine if the print request for a color printout that is stored in the printer queue 28 is from an entity that is authorized to enable the printing of color printouts. The printing system performs this verification function by retrieving a message such as “enter your access code to obtain a color printout” from the message memory 38 of the printing system 20 and forwarding this message to the remote terminal 22, 24 or 26 from which the print request in the printer queue 28 was received. The individual at the remote terminal 22, 24 or 26 responds to the message by entering an access code number that is transmitted from the remote terminal 22, 24 or 26 back to the printer control 30. The printer control 30 compares the entered access code number to a list of valid access codes contained in an access code memory 40. If the entered access code number corresponds to a valid access code number contained in the access code memory 40, the printer control 30 activates the color printing structure 36 to print the requested color print. The printer control 30 also changes the operating mode of the printing system 20 to a color printing mode whereby color printing is enabled by saving the new operating mode of the printing system in the printing state storage memory 34. Once the color printing operating mode of the printing system 20 has been established, color printout requests from the printer queue will be automatically routed to the color printing structure 36 for printing until such time as a user with a valid access code places the printing system back into the black-and-white printing only mode. In an alternative embodiment, the entry of an access code may be required for each color printout to be produced. In yet another embodiment, the entry of an access code may enable color printing for only one specified remote terminal. If an entered access code number does not correspond to a valid access code number stored in the access code memory 40, an error message is retrieved from the message memory 38 and sent to the appropriate remote terminal 22, 24 or 26. The user at the remote terminal 22, 24 or 26 then will be given the opportunity to reenter a valid access code number. Alternatively, the printer control 30 may simply convert the color printout to a grayscale image and print the requested color printout in black-and-white if a valid access code number is not entered.

The embodiment described in FIG. 2 is an improvement in that it enables a user at a remote terminal to control the operating mode of a printer by entering an access code number at the remote terminal. The distribution of the access numbers can be controlled so that the ability to control the operating mode of the printer may be restricted to desired personnel or monitored for excessive usage of the comparatively expensive color printouts. Furthermore, the ability to lock the printer in a color printing mode whereby all print requests for color printouts will be performed without the need to reenter the access code number eliminates the need to constantly reenter the access number when unrestricted color printing is desired. In addition, the embodiment of FIG. 2 provides these benefits without requiring separate color and black-and-white printers. Therefore, the embodiment of FIG. 2 represents a substantial improvement over prior printing systems.

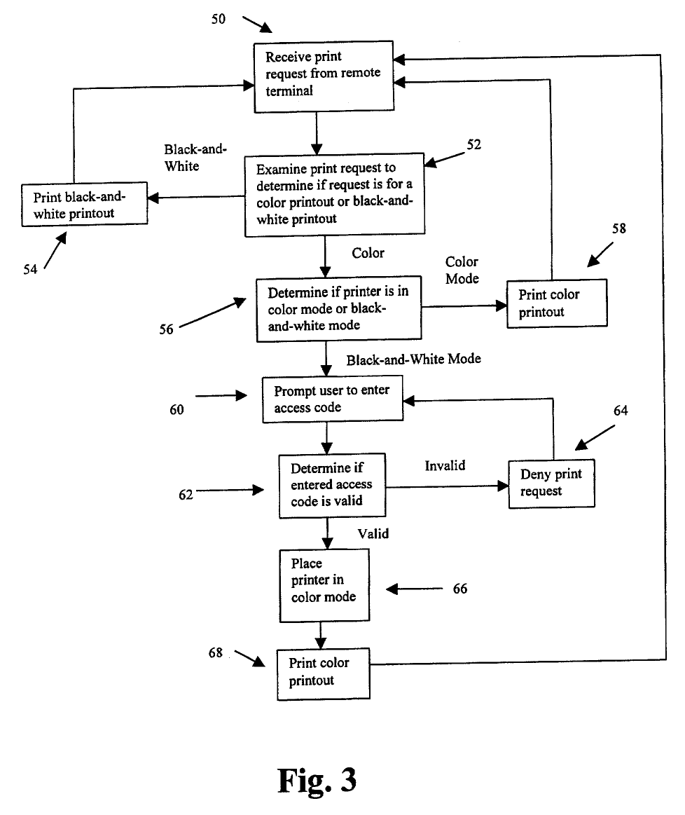

Referring now to FIG. 3, a preferred method of operating a printing system in accordance with the present invention is shown. The method commences with the receiving of a print request from a remote terminal as set forth in block 50. In block 52, the print request is examined to determine if the request is for a color printout or a black-and-white printout. If the request is for a black-and-white printout, the method proceeds to block 54 wherein the requested black-and-white printout is printed. The method then loops back to block 50 wherein the next print request is received and examined. If the request is for a color printout, the method proceeds to block 56 wherein it is determined if the printer in a color printing mode or a black-and-white printing mode. If the printer is in the color printing mode, the method proceeds to block 58 wherein the requested color printout is printed and the method loops back to block 50 wherein the next print request is received and examined. If the printer is in a black-and-white printout only mode, the method proceeds to block 60 wherein the user is prompted to enter an access code. In block 62, the entered access code is examined to determine if it is valid. If the entered access code is invalid, the request to print a color printout is denied as shown in block 64. The method then proceeds to back to block 60 wherein the user is prompted to enter an access code. If the entered access code is valid, the printer is placed in the color printing mode as shown in block 66 and a color printout is produced as set forth in block 68. The method then returns to block 50 wherein the next print request is received from a remote terminal.

Allowing users that have a valid access code to change the operating mode of a printer from a black-and-white printout only mode to a color printing enabled mode allows the number of color printouts produced by the printer to be effectively managed. By limiting the printing of color printouts to those cases where a color printout is truly required, the method of FIG. 3 reduces the costs associated with operating the printer. In addition, the method of FIG. 3 accomplishes this desirable reduction in costs without the need for separate color and black-and-white printers or extensive monitoring and oversight. Therefore, the method of FIG. 3 provides a number of advantages over the prior methods of producing black-and-white and color printouts. Furthermore, while the method of FIG. 3 is directed toward controlling a color laser or ink jet printer, it will be readily appreciated that the present invention is equally applicable to a color copier wherein it could be employed to restrict access to the ability to produce color copies.

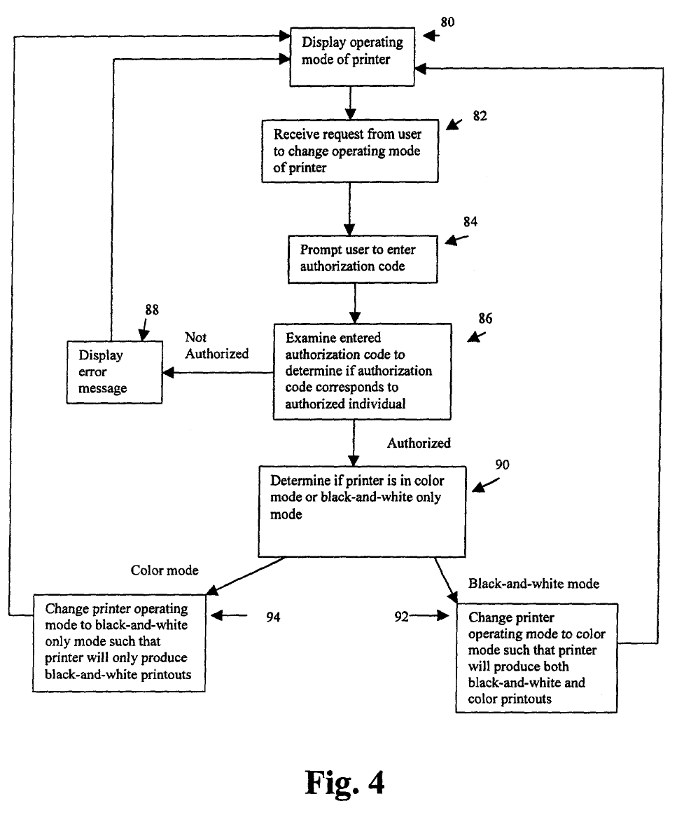

Another method of controlling a printer in accordance with an embodiment of the present invention is illustrated in FIG. 4. The method commences with the displaying of the operating mode of the printer as set forth in block 80. The method then proceeds to block 82 wherein a request in received from a user of the printer to change the operating mode of the printer. In response to the request, the user is prompted to enter an authorization code as shown in block 84. In block 86, the entered authorization code is examined to determine whether or not the entered authorization code corresponds to an authorized individual. If the entered authorization code does not correspond to an authorized individual, an error message is displayed as shown in block 88 and the method proceeds back to block 80 wherein the operating mode of the printer is displayed. If the entered authorization code corresponds to an authorized individual, the method proceeds to block 90 wherein it is determined if the printer is in the color mode or black-and-white only mode. If the printer is in the color mode, the method proceeds to block 94 wherein the operating mode is changed to the black-and-white only mode. If the printer is in the black-and-white only mode, the method proceeds from block 90 to block 92 wherein the operating mode of the printer is changed to the color mode wherein both black-and-white and color prints are enabled. Once the operating mode has been changed in either block 92 or 94, the method returns to block 80 and the new operating mode of the printer is displayed.

It is contemplated, and will be apparent to those skilled in the art from the preceding description and the accompanying drawings that modifications and/or changes may be made in the embodiments of the invention. Accordingly, it is expressly intended that the foregoing description and the accompanying drawings are illustrative of preferred embodiments only, not limiting thereto, and that the true spirit and scope of the present invention be determined by reference to the appended claims.

1. A printer that is capable of producing both color and black-and-white prints, said printer comprising a print mode selection mechanism for selecting between at least two printing modes wherein when said printer is placed in a first printing mode said printer can produce either black-and-white or color prints and wherein when said printer is placed in a second printing mode said printer can produce only black-and-white prints.

2. The printer of claim 1 further comprising a lock mechanism such that when the lock mechanism is engaged the printing mode of the printer can not be changed between the first printing mode and the second printing mode and when the lock mechanism is disengaged the printing mode of the printer can be changed between the first printing mode and the second printing mode.

3. The printer of claim 2 wherein a mechanical key is used to engage and disengage the lock mechanism.

4. The printer of claim 2 further comprising a key pad wherein an operator of the printer must enter an access code through the key pad that is verified by a processor in the printer to engage or disengage the lock mechanism of the printer.

5. A method of controlling a printer that is designed to produce both color and black-and-white printouts, the method comprising:
limiting the printer to only producing black-and-white printouts when the printer is placed in a black-and-white printing mode; and
enabling the printer to produce color printouts when the printer is placed in a color printing mode.

6. The method of claim 5 further comprising the step of limiting the ability of an operator to place the printer in the color mode.

7. The method of claim 5 farther comprising the step of limiting the ability to place the printer in the color printing mode to a limited number of individuals.

8. The method of claim 7 wherein the step of limiting the ability to place the printer in the color printing mode to a limited number of individuals further comprises:
requiring a user desiring to place the printer in the color printing mode to enter a digital access code;
verifying the digital access code against a list of digital access codes that correspond to authorized users to determine whether or not the user is authorized to place the printer in the color printing mode; and
placing the printer in the color printing mode if the digital access code corresponds to a user authorized to place the printer in the color printing mode.

9. The method of claim 5 further comprising the step of limiting the ability of an operator to place the printer in the color printing mode by requiring the operator to use a mechanical key to access the color printing mode.

10. The method of claim 5 further comprising the step of limiting the ability of an operator to place the printer in the color printing mode by requiring the operator to enter a digital access code to access the color printing mode.

11. The method of claim 10 further comprising the step of verifying the digital access code.

12. The method of claim 11 wherein the step of verifying the access code further comprises verifying the access code by comparing the access code to a list of acceptable access codes to determine if the access code is an acceptable access code.

13. A method of controlling a printer wherein said printer is capable of producing both color and black-and-white prints, said method comprising:
examining a set of printing instructions to determine if the instructions request the printing of a color print or a black-and-white print;
producing a black-and-white print if the printing instructions indicate that a black-and-white print has been requested;
producing a color print if the printing instructions indicate that a color print has been requested and a color printing mode is enabled; and
producing an error message if the printing instructions indicate that a color print has been requested and the color printing mode is not enabled.

14. The method of claim 13 wherein the step of producing an error message further comprises prompting a user to enter an access code if the printing instructions indicate that a color print has been requested and the color printing mode is not enabled and enabling the color printing mode if the entered access code corresponds to an authorized access code.

15. The method of claim 13 further comprising the step of allowing a user to selectively disable or enable the color printing mode.

16. The method of claim 13 further comprising the step of limiting the number of users that can alter the printing mode of the printer to a selected subset of users.

17. The method of claim 16 wherein the step of limiting the number of users further comprises prompting users to enter an identification code and allowing a user to change the printing mode of the printer if the entered identification code corresponds to an authorized identification code.

18. A printer for printing color and black-and-white images wherein the printer operates in either a locked mode or an unlocked mode such that when the printer is in the locked mode the printer will only print black-and-white images and when the printer is in the unlocked mode the printer will print either black-and-white or color images.

19. The printer of claim 18 further comprising an access system that only allows authorized individuals to change the operating mode of the printer from the locked mode to the unlocked more.

20. The printer of claim 19 wherein the access system further comprises an identification system that prompts a user to enter an authorization number and then compares the entered authorization number to a data base of valid authorization numbers to determine if the user is authorized to change the operating mode of the printer.
